(19) United States
(12) Patent Application Publication
(10) Pub. No.: US 2017/0040709 A1
(43) Pub. Date: Feb. 9, 2017

(54) RADAR APPARATUS

(71) Applicant: NIDEC ELESYS CORPORATION, Kawasaki-shi (JP)

(72) Inventor: Akira ABE, Kawasaki-shi (JP)

(21) Appl. No.: 15/208,811

(22) Filed: Jul. 13, 2016

(30) Foreign Application Priority Data
Aug. 4, 2015 (JP) 2015-154545
Sep. 4, 2015 (JP) 2015-174942
Jun. 3, 2016 (JP) 2016-111770
Jun. 29, 2016 (JP) 2016-128970

(51) Int. Cl. H01Q 19/13; H01Q 1/32

(52) U.S. Cl. CPC H01Q 19/13; H01Q 1/3275

(57) ABSTRACT

A radar apparatus of the present invention is provided with at least one horn antenna for radiating and receiving linearly-polarized radio waves. The inner circumferential surface of the horn antenna has a top surface and a bottom surface, and a right side surface and a left side surface facing each other, the top surface and the bottom surface being perpendicular to a direction of the electrical field and facing each other. The top surface and the bottom surface define a first steeply-widened portion having a first rate of a widening rate, and define a first gently-widened portion having a second rate of a widening rate, the second rate being lower than the first rate. High-order modes can be generated within the horn antenna by the first steeply-widened portion and the first gently-widened portion to reduce sidelobes in the elevation angle direction.

### BACKGROUND OF THE INVENTION

1. Field of the Invention

The present invention relates to a radar apparatus using a rectangular horn antenna.

2. Description of the Related Art

In recent years, radar apparatuses have rapidly become widespread as sensor equipment for the collision mitigation and anti-collision control for commercially-available automobiles. For future advanced safety functions, there are needs for the protection for two-wheel vehicle riders and pedestrians and driver assistance for invisible areas. Diversified functions of automotive safety devices now entail widening of view angles, an increase in the detectable distance, and an improvement in the rate of recognition for objects to be detected.

### SUMMARY OF THE INVENTION

The present invention is intended to reduce sidelobes in an elevation angle direction in cases where a rectangular horn is used as an antenna of, for example, a radar for vehicle installation. A vehicle-mounted radar is aimed at monitoring a horizontal planar area in the forward and lateral directions of a vehicle to detect only the objects within this area. A radar antenna therefore generally has flat, sector-shaped beam characteristics, wide in the horizontal direction and narrow in the elevation angle direction. In addition, sidelobes in the elevation angle direction have to be reduced as much as possible, so as not to detect structures, such as land bridges and traffic lights, located above the vehicle as obstacles in the forward direction. The aperture of the antenna thus has a vertically-elongated shape, wide in the vertical direction, in order to obtain the flat, sector-shaped beam characteristics in the elevation angle direction. In an antenna system, such as a printed antenna, other than rectangular horns, radiating elements are arranged in the vertical direction or a linear array of the elements is used in many cases. In that case, sidelobes in the direction of the array, i.e., in the elevation angle direction may be reduced by distributing electrical power to be fed to each radiating element, so as to be high in the middle of the antenna and low at both ends thereof. However, in the case of a commonly-used rectangular horn, i.e., a rectangular waveguide having a shape in which the height and width of the waveguide are gradually widened, it is difficult to control the electrical power distribution in the aperture of the antenna.

An object of the present invention, which has been accomplished in view of the above-described points of discussion, is to suppress sidelobes in cases where a rectangular horn is used as a radiator in an antenna of a radar or the like installed in a vehicle interior.

The present invention is a radar apparatus provided with an antenna member including at least one horn antenna for performing at least one of the radiation and reception of linearly-polarized radio waves and a waveguide for transferring the radio waves; and at least one circuit for performing at least one of the generation and reception of the radio waves, wherein the base portion of the horn antenna and the waveguide are connected, the waveguide and the circuit are coupled, the horn antenna has a funnel shape extending from the base portion to the aperture of the antenna, a cross-section of the horn antenna in a plane perpendicular to the axis of the horn antenna has a rectangular shape, the area of the cross-section gradually increases from the base portion toward the aperture, the inner circumferential surface of the horn antenna has a top surface and a bottom surface extending from the base portion toward the aperture, and a right side surface and a left side surface connecting the top surface and the bottom surface and facing each other, the top surface and the bottom surface being perpendicular to the direction of the electrical field of the radio waves and facing each other, and the top surface and the bottom surface define a first steeply-widened portion having a first rate of a widening rate of a distance between the top surface and the bottom surface, and define a first gently-widened portion having a second rate of a widening rate of a distance between the top surface and the bottom surface, the first gently-widened portion being positioned closer to the aperture than the first steeply-widened portion, the second rate being smaller than the first rate.

According to one exemplary preferred embodiment of the present invention, it is possible to obtain a radar apparatus with reduced sidelobes in an elevation angle direction.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A-1C is a schematic view illustrating a horn antenna of a first preferred embodiment, in which FIG. 1A is a front view taken from the aperture side, FIG. 1B is a horizontal cross-sectional view, and FIG. 1C is a vertical cross-sectional view;

FIG. 2 is an example of the radiation characteristics of the horn antenna according to the first preferred embodiment of the present invention;

FIG. 3A-3D is a schematic view illustrating the electrical field distribution of each mode according to the present invention;

FIG. 4 is a graphical view showing calculated values of radiation characteristics of radio waves in an elevation angle direction according to the present invention;

FIG. 5A-5C is a schematic view illustrating a horn antenna of a second preferred embodiment, in which FIG. 5A is a front view taken from the aperture side, FIG. 5B is a horizontal cross-sectional view, and FIG. 5C is a vertical cross-sectional view;

FIG. 6 is an example of the radiation characteristics of the horn antenna according to the second preferred embodiment of the present invention;

FIG. 7A-7C is a schematic view illustrating a horn antenna of a third preferred embodiment, in which FIG. 7A is a front view taken from the aperture side, FIG. 7B is a horizontal cross-sectional view, and FIG. 7C is a vertical cross-sectional view;

FIG. 8A-8C is a schematic view illustrating a conventional standard rectangular horn antenna, in which FIG. 8A is a front view taken from the aperture side, FIG. 8B is a horizontal cross-sectional view, and FIG. 8C is a vertical cross-sectional view;

FIG. 9 is a perspective view illustrating a radar apparatus of the present invention; and

FIG. 10 is a vertical cross-sectional view of the radar apparatus of the present invention.

### DETAILED DESCRIPTION OF THE PREFERRED EMBODIMENTS

Hereinafter, preferred embodiments will be described with reference to the accompanying drawings.

It should be noted that drawings to be used in the following description may be illustrated with non-characteristic portions excluded.

An X-Y-Z coordinate system is shown in each drawing. In the following description, each portion will be discussed as necessary, according to each coordinate system.

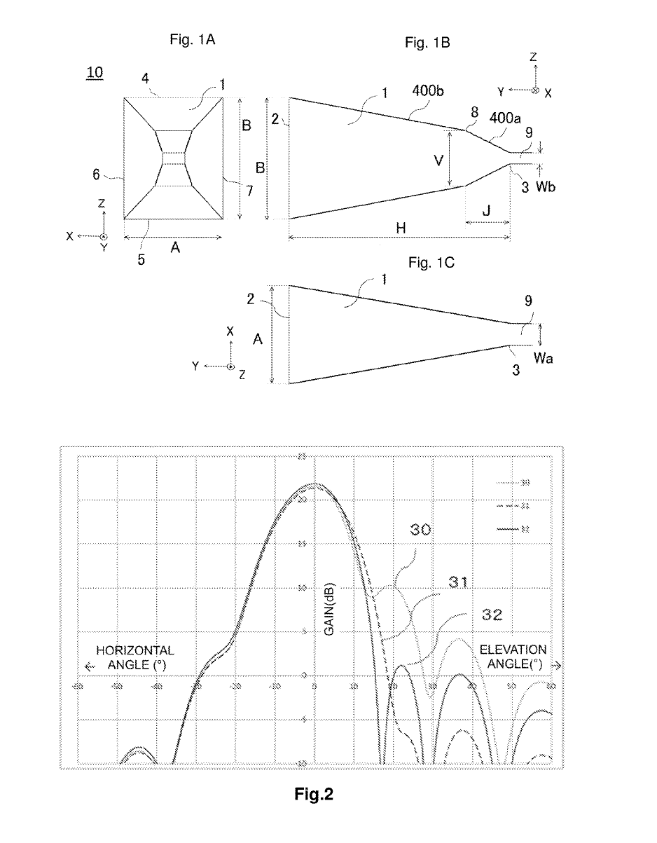

FIG. 1 illustrates an antenna member 10. The antenna member 10 is used in, for example, a radar apparatus for radiating and receiving radio waves of a millimeter waveband. The antenna member 10 includes a horn antenna 1 and a rectangular waveguide 9 to guide and radiate high-frequency electrical power by the rectangular waveguide 9 and the horn antenna 1, respectively. That is, the horn antenna 1 in this case is a radiating horn antenna. In addition, radio waves of a millimeter waveband are received by the horn antenna 1 and guided by the rectangular waveguide 9. The rectangular waveguide 9 is a waveguide having a rectangular cross-section perpendicular to the axial direction thereof.

In general, a horn antenna refers to a funnel-shaped member that widens in a sector-like manner. In the present application, however, the term “horn antenna” is used in a slightly different sense. Since the present invention focuses on a hollow portion through which radio waves are guided, this hollow cavity is referred to as the horn antenna. It should be noted that the hollow cavity has to be surrounded by conducting walls.

Accordingly, if, for example, one block-shaped member made of a conductor includes three forward-widened hollow cavities, then that one member is considered to have three horn antennas. A bundle of three forward-widened funnels made of a conductor is also considered as three horn antennas.

More particularly, the horn antenna refers to a hollow cavity extending from the base portion to the aperture, where the cross-sectional area of the hollow cavity in a plane perpendicular to a direction in which the hollow cavity extends continuously widens from the base portion toward the aperture.

The aperture of the horn antenna may also be described as an opening. Here, the rectangular horn antenna refers to a horn antenna having a rectangular cross-section of an internal space when the horn is cut in a plane perpendicular to a direction in which the horn antenna is oriented. Note that, in this description or in a claim, the direction in which the horn antenna is oriented means a direction in which the aperture is viewed from the base portion of the horn antenna.

Hereinafter, the shape of the horn antenna 1 will be described.

The horn antenna 1 is reflectively symmetrical in the vertical and horizontal directions. The width of an aperture 2 is denoted by A, the height of the aperture 2 is denoted by B, and the depth of the aperture 2 to a base portion 3 opposite to the aperture 2 is denoted by H. A rectangular waveguide 9 serving as the input and output ends of radio waves is connected to the base portion 3. The horn antenna 1 is capable of guiding and receiving linearly-polarized radio waves. The direction of polarization is determined by the rectangular waveguide 9. The cross-section of the rectangular waveguide 9 perpendicular to the axial direction of the waveguide is rectangular, and the width and height of the waveguide are denoted by Wa and Wb, respectively. Vertically-polarized (the electrical field of radiation waves is directed in the vertical direction) radio waves can be guided if such a horizontally-elongated shape as illustrated in the figure is selected with Wa and Wb defined as Wa<λ and Wb<λ/2, which will be discussed in detail later. Here, λ is the free-space wavelength of radio waves at a frequency used, where λ=3.92 mm at 76.5 GHz used in a vehicle-mounted radar. The external shape of the horn antenna 1 is pyramidal, and the four side surfaces of the antenna are made of a conductor. Although the side surfaces made of a conductor actually have thicknesses, only the hollow internal space surrounded by the side surfaces can electrically function as a horn antenna. Accordingly, the figure shows only a top surface 4, a bottom surface 5, a left side surface 6 and a right side surface 7.

One end of the rectangular waveguide 9 is connected to the base portion of the horn antenna 1. The electrical field direction of linearly-polarized waves is perpendicular to the top surface 4 and the bottom surface 5 of the horn antenna 1.

In the present invention, the top surface 4 and the bottom surface 5 include widened portions in which the distance between the top and bottom surfaces in the height direction increases from the base portion 3 toward the aperture 2. Each widened portion includes a first steeply-widened portion 400a having a heightwise widening rate that is a first rate, and a first gently-widened portion 400b positioned closer to the aperture 2 than the first steeply-widened portion 400a and having a heightwise widening rate that is a second rate. The second rate is smaller than the first rate. Each rate refers to a rate of the distance of deviation from an axis connecting the centers of the aperture and base portion to a rate of the distance of advance, with reference to the axis, when the widened portion advances from the base portion toward the aperture. An increase in the rate means a longer distance of deviation. For example, one rate being smaller than the other rate means that an angle formed by the axis of the horn antenna and one widened portion is smaller than an angle formed by the axis of the horn antenna and the other widened portion. A length from the base portion 3 to the opposite end of the first steeply-widened portion 400a in the axial direction of the horn antenna is denoted by J, and a vertical height at a point where the steeply-widened portion 400a having the first rate changes to the first gently-widened portion 400b is denoted by V.

A commonly-used rectangular horn antenna is referred to as a standard rectangular horn antenna. FIG. 8 illustrates a standard rectangular horn antenna 500. Here, in connection with the standard rectangular horn antenna 500, discussions in ANTENA KOGAKU HANDOBUKKU (Antenna Engineering Handbook) (2nd ed.), pp. 293-297, (hereinafter referred to as Non-patent Literature 1) will be introduced.

The standard rectangular horn antenna 500 has such a shape that a rectangular waveguide is gradually widened, as illustrated in FIG. 6.4 in Non-patent Literature 1. In contrast, according to the present invention, bent portions 8 with a discontinuous change of the widening rate are added to the horn antenna 500 at inner wall surfaces intersecting with an electrical field direction.

FIG. 2 illustrates an example of the radiation characteristics of the horn antenna 1 according to the present invention. The horn antenna 1 is reflectively symmetrical in the vertical and horizontal directions of the antenna. Accordingly, in order to avoid redundant illustration, FIG. 2 shows directional characteristics only in the upward elevation angle direction of the antenna in the right half plane of the figure and directional characteristics only in the horizontal left-hand direction of the antenna in the left half plane of the figure, with the front direction of the antenna from the aperture plane of the aperture 2 as the center. The horizontal axis represents an elevation angle with the front direction defined as 0° in the right half plane of the figure and a direction angle with the front direction defined as 0° in the left half plane. A dotted line 30 indicates the directional characteristics of the standard rectangular horn antenna 500 shown as a comparative example. If the depth is increased to as much as H>1.2B2/λ, sidelobes will be reduced by approximately 3 dB from those shown in the figure. The sidelobes will not be improved any more than that value even if the dimensions of the portions of the horn antenna are adjusted. A dashed line 31 and a solid line 32 represent the directional characteristics of the horn antenna 1 according to the present invention. As illustrated in the figure, the sidelobes are greatly reduced in the directional characteristics in the elevation angle direction. The dashed line 31 indicates directional characteristics when the horn antenna is designed with emphasis on sidelobe reduction. In this case, a beam width becomes wider than that of the directional characteristics indicated by the dotted line 30, causing a peak (0° direction) gain to decrease. The solid line 32 indicates directional characteristics when the horn antenna is designed so as to reduce the sidelobes as much as possible, while securing the same peak gain as indicated by the dotted line 30.

In either case of design, the aperture dimensions of the horn antenna are defined as A=16 mm in width, B=16 mm in height, and H=40 mm in depth. The dimensions of each widened portion are defined as J=2.8 mm and V=6.6 mm for a horn antenna exhibiting the characteristics indicated by the dashed line 31, and as J=4.4 mm and V=7 mm for a horn antenna exhibiting the characteristics indicated by the solid line 32. A length measured from the base portion to the aperture is equal to the depth H.

The circuit measures a distance to an object using a Frequency Modulated Continuous-Wave (FMCW) modulation, for example. The circuit removes beat signals having frequencies lower than a predetermined frequency by using filters, for example. By that process, distances smaller than 1 m are not measured in this preferred embodiment. However, if so desired, distances smaller than 1 m might be measured if the condition of the signal processing is properly tuned. But such smaller distances are not as valuable because it is unclear whether electric fields suitable to radar measurements are generated by the horn antenna adopted by the preferred embodiments of the present invention at places nearer than ten times the depth H of the horn. Accordingly, measured distances may not be as reliable for such small distances. The same limit is applied when the radar of the preferred embodiments of the present invention uses other modulation methods, such as a pulse-doppler method, for example.

In addition to these design examples, design simulations were run with B ranging from 3λ to 8λ and H ranging from 8λ to 20λ. Simulation results show that it is effective for the sake of sidelobe reduction to make changes to the widened portions, so that the slope of each widened portion is steep on the base portion 3 side and gentle on the aperture 2 side. That is, each widened portion preferably has a structure including a first steeply-widened portion 400a having a heightwise widening rate that is a first rate, and a first gently-widened portion 400b positioned closer to the aperture 2 than the first steeply-widened portion 400a and having a heightwise widening rate that is a second rate, where the second rate is lower than the first rate. Note that in horizontal characteristics, no significant differences are observed in a beam width and a pattern shape. Accordingly, effects exerted by the widened portions of the top surface 4 and the bottom surface 5 are considered to appear only in elevation-angle characteristics. These effects are attributable to high-order modes of high-frequency electrical power within the horn antenna 1. The high-order modes will be described later.

Also in the horn antenna 1, an internal electrical field intensity distribution is determined as being the same as a steady-state solution (if the waveguide extends linearly while keeping the same inner wall cross-sectional shape) to the internal electrical field intensity distribution of the rectangular waveguide 9. An electromagnetical field within the rectangular waveguide 9 propagates while taking an intrinsic mode determined according to the size and shape of the inner wall surfaces. Two modes used in the present invention are referred to as TE10 and TE12. The electrical-field components of TE modes are given by Equations 1 and 2 shown below as general formulas. One of the four corners of a rectangular cross-section is defined as an origin O, the direction of electrical fields is defined as a y direction, and a direction perpendicular to the y direction is defined as an x direction. At this time, electrical fields are given by Equations 1 and 2 shown below for side lengths wa and wb in the x and y directions.

$$\begin{matrix}{E}_{x} = - {α}_{mn} \cdot cos ( \frac{m π x}{{w}_{a}} ) \cdot sin ( \frac{n π y}{{w}_{b}} ) & Equation 1 \\ {E}_{y} = {α}_{mn} \cdot sin ( \frac{m π x}{{w}_{a}} ) \cdot cos ( \frac{n π y}{{w}_{b}} ) & Equation 2\end{matrix}$$

where m and n=0, 1, 2, . . . , except when m and n are simultaneously equal to 0. Ex denotes an electrical-field component in the x direction, Ey denotes an electrical-field component in the y direction, and αmn denotes the magnitude of the electrical component of each mode. A different intrinsic mode, which is referred to as a TEmn mode, is available according to the values of m and n. A cutoff wavelength λc exists according to each mode.

$$λ c = {2 [ {( \frac{m}{{w}_{a}} )}^{2} + {( \frac{n}{{w}_{b}} )}^{2} ]}^{- \frac{1}{2}} \qquad Equation 3$$

If the free-space wavelength λ of a certain mode is longer than this cutoff wavelength, i.e., if the frequency of the mode is lower than a frequency based on the cutoff wavelength, that mode is unable to exist within the rectangular waveguide (the mode is cut off). A mode having the longest cutoff wavelength and a vertically-directed (y direction) electrical field is the TE10 mode, where electrical-field components in the x and y directions are given by the following equations:

$$\begin{matrix}{E}_{x} = 0 & Equation 4 \\ {E}_{y} = {α}_{10} \cdot sin ( \frac{π x}{{w}_{a}} ) & Equation 5\end{matrix}$$

In general, the dimensions of the rectangular waveguide 9 are designed so that only the TE10 mode can exist within the waveguide. Conditions for this to be true are λ/2<wa<λ and wb<λ/2. The TE10 mode is referred to as a dominant mode, whereas other modes are referred to as high-order modes (higher modes). In the horn antenna 1, only the dominant mode exists within the rectangular waveguide 9 serving as input and output ends. However, high-order modes can also exist if the rectangular cross-section of inner walls is widened. High-order modes do not arise in the case of the standard rectangular horn antenna 500, i.e., a horn antenna having a cross-section that gradually and continuously widens. Thus, only the dominant mode is transmitted to the aperture plane. However, providing a discontinuous change to the widened portions can generate high-order modes.

In the horn antenna 1 of the present invention, a bent portion 8 having a widening rate that varies discontinuously is added to each widened portion of inner wall surfaces orthogonal to the electrical field direction. Consequently, a TE1n mode which is a high-order mode is generated by the bent portions 8. The discontinuous change of the widening rate causes part of TE10-mode electrical power to be converted to the TE1n mode. In this case, n is equal to or greater than 1, and the cutoff wavelength lengthens in the order of TE11, TE12, TE13, . . . . Here, the TE11 and TE13 modes, in which the directions of upper-side and lower-side electrical fields are opposed to each other, are not generated unless there is any significant asymmetry between the top and bottom surfaces of the horn antenna. Accordingly, the TE11 and TE13 modes are not generated in the horn antenna 1. According to Equation (3), the vertical lengths V of the horn antenna 1 in height need to be made larger than at least λ, in order to generate the TE12 mode. In addition, it is possible to prevent the TE14 mode from being generated by setting the vertical height as approximately V<2λ. As a result, the TE10 and TE12 modes mixedly exist in the aperture plane.

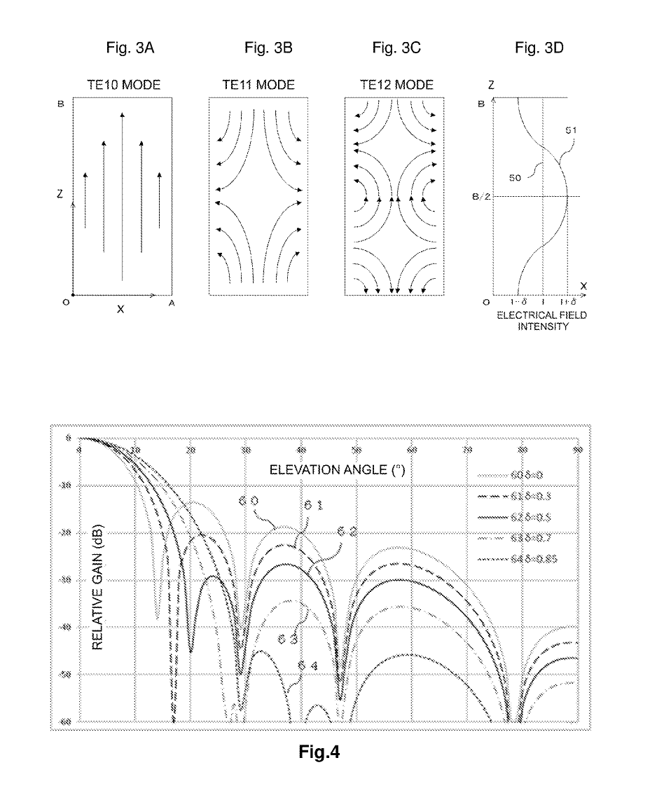

FIGS. 3A, 3B and 3C schematically illustrate the electrical field distributions of the TE10, TE11 and TE12 modes. The directions of arrows represent the directions of electrical fields, whereas the lengths of arrows represent the magnitudes of electrical fields which are electrical field intensity. The figures show that electrical field intensity becomes higher with an increase in the length of each arrow. If the directions of arrows are the same, the phases of electrical fields are the same. If the directions of electrical fields are opposed to each other, the electrical fields oscillate in the opposite phase. In the TE10 mode of FIG. 3A, for example, the electrical fields oscillate in the same phase over the entire horn antenna. On the other hand, in the TE11 mode of FIG. 3B, the electrical fields oscillate with a phase difference of π between the upper half and lower half of the horn antenna. In the TE12 mode of FIG. 3C, the directions of electrical fields are opposite to each other in the vertical direction at the central portion and on the upper and lower wall surfaces. Accordingly, if the phase is adjusted so that the directions of TE10-mode and TE12-mode electrical fields are the same at the central portion, TE10-mode and TE12-mode electrical field intensities are summed. Consequently, the electrical field intensity of electrical fields in the vertical direction is high at the central portion and low on the wall surfaces. Sidelobes can thus be reduced by such adjustment of the electrical fields within the horn antenna.

FIG. 3D is a graph showing an electrical field intensity distribution within the horn antenna, where the axis of ordinates represents the y-direction position, and the axis of abscissas represents electrical field intensity. A dotted line 50 indicates the electrical field intensity distribution of the TE10 mode alone, where the electrical field intensity is uniform in the y direction. A solid line 51 indicates an electrical field intensity distribution in which the TE10 and TE12 modes are synthesized with reference to a line (=1) denoted by reference numeral 50. The electrical field intensity distribution of FIG. 3D is given by the following equation:

$${E}_{y} = sin ( \frac{π x}{a} ) \cdot [ 1 - δ cos ( \frac{2 π y}{b} ) ] \qquad Equation 6$$

This equation is a relative-value representation of Equation 5 in which α10=1 and α12/α10=δ.

FIG. 4 shows the calculated values of the radiation characteristics of radio waves in the elevation angle direction when the horn antenna has therein this electrical field intensity distribution. In an actual horn antenna, a wavefront shift occurs as illustrated in FIG. 6.3 of Non-patent Literature 1, thus causing the phase to become more delayed on the top and bottom surfaces of the aperture than at the central portion. This phase difference gives rise to such a characteristic change as illustrated FIG. 66 of the literature. However, a condition in which the phase lag is sufficiently small is assumed in FIG. 4. A thin line 60 indicates directional characteristics when δ=0, i.e., the TE10 mode alone is present. A dashed line 61, a solid line 62, a chain line 63, and a dotted line 64 indicate directional characteristics when δ=0.3, 0.5, 0.7, and 0.85, respectively. Sidelobes are reduced further with the increase of δ, and are minimum when δ is equal to approximately 0.85. However, the beam width widens, which makes it no longer possible to achieve the original purpose of obtaining beam characteristics narrow in the elevation angle direction. The beam width is inversely proportional to the height B of the aperture, as long as the value of δ is the same. In FIG. 4, the beam width is approximately 1.4 times wider when δ=0.85, compared with a case where δ=0.3. Accordingly, in order to obtain the same beam width as that when δ=0.3 in FIG. 4 at the same gain as in the case of sidelobes when δ=0.85, the value of B needs to be made 1.4 times larger. This means an increase in the dimensions of the antenna/radar apparatus. The magnitude of the second sidelobe is obviously reduced even when δ=0.3, and the aim of the invention is therefore achieved. From the knowledge gained thus far, it is considered appropriate to select the value of δ within the range of 0.3 to 0.7. In FIG. 2 discussed earlier, the dashed line 31 represents directional characteristics when δ=0.58, whereas the solid line 32 represents directional characteristics when δ=0.36.

Note that in addition to the TE12-mode electrical field intensity, a phase relative to the phase of the dominant mode needs to be adjusted as well. In the design discussed herein, the phase is adjusted to the optimum one by a method of selecting the optimum shape (J and V dimensions of the widened portions) using an electromagnetic field simulator.

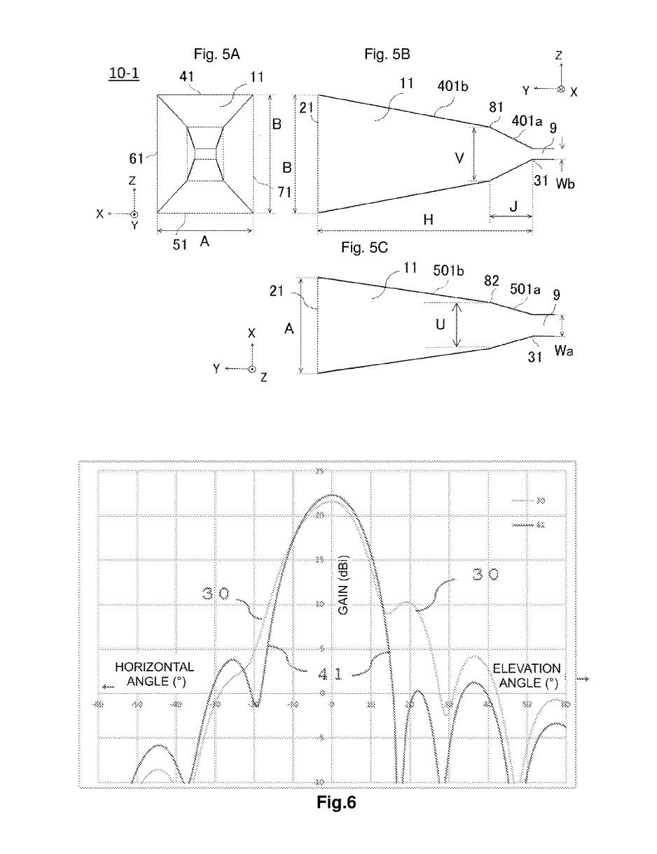

FIG. 5 illustrates an antenna member 10-1 according to a second preferred embodiment of the present invention. FIG. 5A is a front view, FIG. 5B is a side view, and FIG. 5C is a top view. The second preferred embodiment is the same as the first preferred embodiment illustrated in FIG. 1B in that a horn antenna 11 is provided with bent portions 81 on a top surface 41 and a bottom surface 51, but differs from the first preferred embodiment in that the horn antenna 11 is also provided with bent portions 82 on a left side surface 61 and a right side surface 71. That is, the horn antenna 11 includes a second steeply-widened portion 501a having a widthwise widening rate that is a third rate, and a second gently-widened portion 501b positioned closer to a aperture 21 than the second steeply-widened portion 501a and having a widthwise widening rate that is a fourth rate, where the fourth rate is smaller than the third rate. A length from a base portion 31 to the opposite end of the second steeply-widened portion 401a in the axial direction of the horn antenna is denoted by J, and the width of a hollow cavity within the horn antenna at a boundary where the second steeply-widened portion 401a changes to the second gently-widened portion 401b is denoted by U.

FIG. 6 shows the radiation characteristics of the horn antenna 11. The dotted line 30 indicates the directional characteristics of the same standard rectangular horn antenna 500, as illustrated in FIG. 2, whereas a solid line 41 represents the directional characteristics of an antenna having the structure illustrated in FIG. 5.

FIG. 6 shows that in addition to the suppression of sidelobes in the elevation angle direction, a 0.7 dB increase in peak gain has been achieved in the elevation angle direction and the horizontal direction. The bent portions 82 provided on the left side surface 61 and the right side surface 71 of the horn antenna 11 generate a TE30 mode which is a high-order mode. Consequently, it is possible to modify the electrical field distribution in the horizontal direction to improve radiation efficiency. The aperture size, the depth, and the dimensions of the rectangular waveguide are the same as in the case of FIG. 3, where the widened portion represented by the solid line 41 is sized as J=5 mm, V=7.2 mm, and U=7.2 mm.

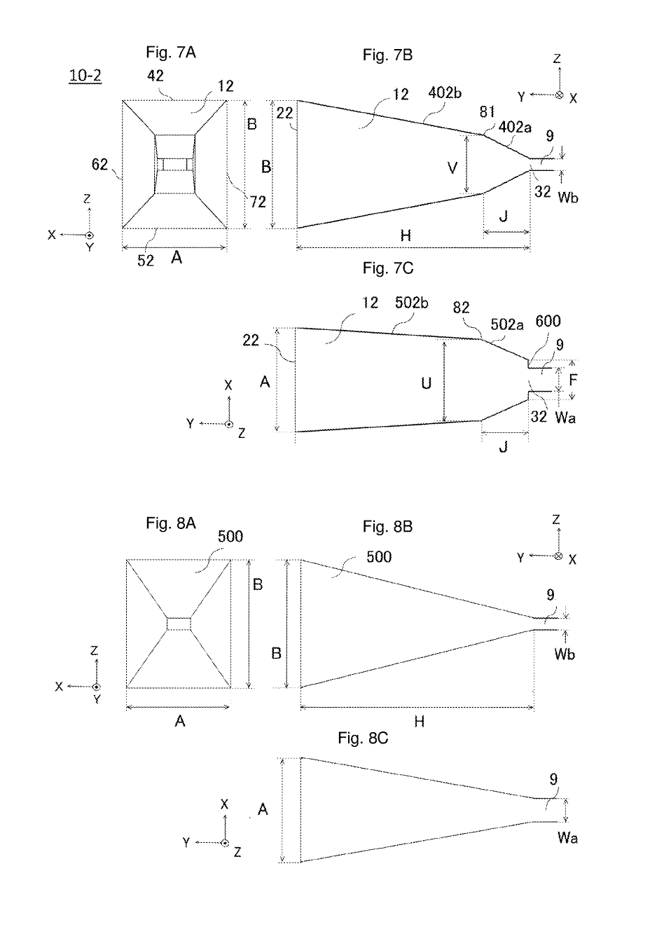

FIG. 7 illustrates an antenna member 10-2 according to a third preferred embodiment of the present invention. FIG. 7A is a front view, FIG. 7B is a side view, and FIG. 7C is a top view. A horn antenna 12 illustrated in FIG. 7 further includes, in the base portion 32, a stepped structure having a transverse width discontinuously increasing from Wa to F in the long-side direction of the rectangular waveguide 9. That is, the horn antenna 12 includes a planar portion 600 connecting the base portion 32 and the first steeply-widened portion 402a and extending perpendicularly to the axis of the horn antenna 12. In addition, portions the same as those of FIG. 1 are denoted by the same reference numerals and characters.

The stepped structure of the horn antenna 12 generates the TE30 mode. Consequently, it is possible to modify the electrical field distribution in the horizontal direction to improve radiation efficiency. Adjustments need to be made separately to the generated amount of each of the TE12 and TE30 modes and to the phase of each mode relative to the dominant mode. From the viewpoint of design, V and U are mainly selected for the generated amount of each mode and J and F are mainly selected for the phase, in an appropriate manner.

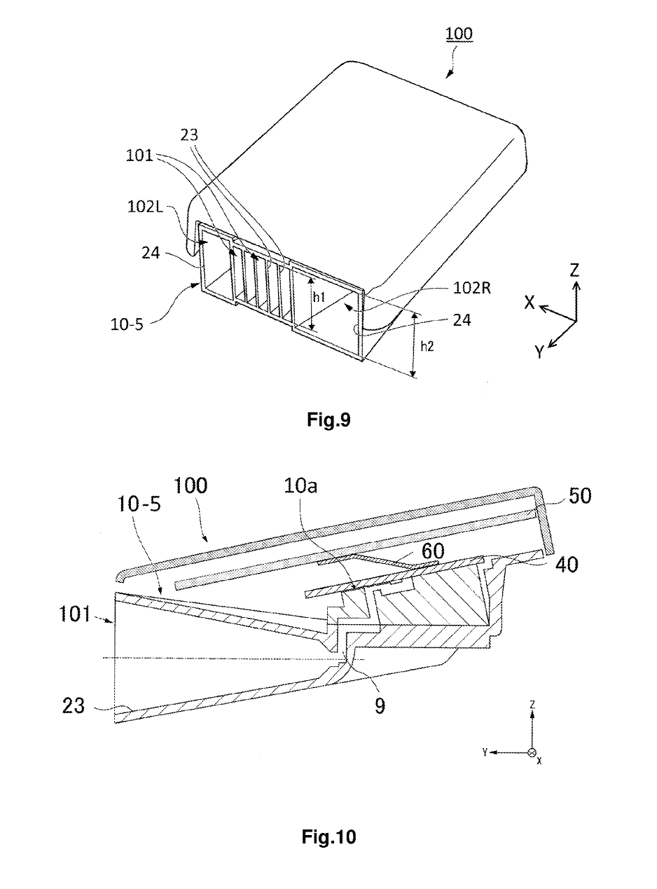

FIG. 9 is a perspective view illustrating an external configuration of a radar apparatus 100 including horn antennas. FIG. 10 is a schematic vertical cross-sectional view of the radar apparatus 100. FIG. 10 is a cross-sectional view presented by appropriately selecting a cross-section along an appropriate plane passing through each portion to be described, rather than a cross-section along one plane, in order to show the portion in an easy-to-understand manner. The radar apparatus 100 is, for example, a radar apparatus for radiating and receiving radio waves of a millimeter waveband. The radar apparatus 100 is installed facing, for example, forward of a vehicle to detect objects ahead of the vehicle.

As illustrated in FIGS. 9 and 10, the radar apparatus 100 includes an antenna member 10-5; a radar control board (circuit) 40; and a power-supply circuit board 50.

The antenna member 10-5 is provided with a receiving horn antenna 101 for receiving radar waves, a radiating horn antenna 102 for radiating radar waves, and a rectangular waveguide 9 having a rectangular cross-section. One end of the rectangular waveguide 9 is connected to the base portion of each horn antenna.

The radar control board 40 is mounted on an upper surface 10a of the antenna member 10-5. The power-supply circuit board 50 is located above the radar control board 40 and connected to the radar control board 40 using a wire 60.

The radar apparatus 100 guides high-frequency electrical power output by a transmitting circuit within the radar control board 40 through the rectangular waveguide 9, and radiates the electrical power from the radiating horn antenna 102 of the antenna member 10 as radar waves. The frequency of the high-frequency electrical power belongs to a 76.5 GHz waveband in this example. In addition, the radar apparatus 100 captures radar waves reflected from a detection object with the receiving horn antenna 101, guides the radar waves through the rectangular waveguides 9, and receives the radar waves with a receiving circuit within the radar control board 40.

Here, the base portions of the receiving horn antenna 101 and the radiating horn antenna 102 may not necessarily be connected to the rectangular waveguides. For example, slots may be provided in the waveguides to guide radio waves to the respective base portions through the slots or guide the radio waves to the radar control board through the slots. Any guidance structure to be coupled to each base portion can be employed, as long as the radio waves can consequently be guided from the radar control board to the horn antenna or from the horn antenna to the radar control board.

Note that in the following description, the +Y direction and the −Y direction in FIG. 10 that are directions in which radar waves are radiated from the antenna member 10-5 are defined as a forward direction and a backward direction, respectively. In addition, the +X direction, the −X direction, the +Z direction, and the −Z direction in FIG. 10 when the antenna member 10-5 is viewed from the forward direction (+Y direction) are defined as a rightward direction, a leftward direction, an upward direction, and a downward direction, respectively.

Also note that each direction does not necessarily represent the direction of the radar apparatus 100 of the present preferred embodiment when the radar apparatus is mounted on a vehicle body. Accordingly, for example, the radar apparatus 100 can be assembled into a vehicle in an upside-down manner.

Hereinafter, constituent parts of the radar apparatus 100 will be described in detail.

As illustrated in FIGS. 9 and 10, the antenna member 10-5 includes five receiving horn antennas 101 lining up side by side in the width direction (X-axis direction) thereof and forming a row in the width direction; and two radiating horn antennas 102 positioned at the leftmost and rightmost ends of the row of the receiving horn antennas 101.

As illustrated in FIG. 9, the apertures 23 of the five receiving horn antennas 101 have the same shape and the same height h1.

The radiating horn antennas 102 are positioned on the left and right of a row of the receiving horn antennas 101. When the radiating horn antennas 102 positioned on the left and right are described individually, the horn antenna positioned on the right side (+X side) of the row of the receiving horn antennas 101 is referred to as a rightmost horn antenna 102R, whereas the horn antenna positioned on the left side (−X side) is referred to as a leftmost horn antenna 102L. The shape of each horn antenna is as described above, and therefore, will not be discussed here.

As radiating horn antennas, two types of horn antenna are prepared according to the distance between a vehicle and a target. In the present invention, the leftmost horn antenna 102L radiates radar waves toward objects located on the roadway relatively close to a vehicle provided with the radar apparatus 100 to detect the objects. On the other hand, the rightmost horn antenna 102R detects objects located on the roadways distant from the vehicle and relatively tall objects and the like. Note that the positions in which the rightmost horn antenna 102R and the leftmost horn antenna 102L are mounted are mentioned by way of example only, and therefore, the horn antenna for long distances may be mounted on the leftmost end.

As illustrated in FIG. 9, the apertures 24 of the rightmost horn antenna 102R and the leftmost horn antenna 102L have a second-type height h2. The second-type height h2 is larger than the first-type height h1 of the receiving horn antennas 101.

The above-described configuration allows the radar apparatus 100 to reduce sensitivity at sidelobes in a product of the gains of a radiating antenna and a receiving antenna. In addition, the heightwise centers of the receiving horn antennas 101 and the radiating horn antennas 102 can be aligned with each other to enable the radar apparatus 100 to further facilitate the removal of sidelobes in the radiating horn antennas 102.

The radar apparatus disclosed herein is not limited to the structures described in the present disclosure, but may be modified in various other ways within the technical scope of the present disclosure. For example, a member or a structure used to couple the base portion of a horn antenna and a circuit is not limited to a waveguide. In addition to waveguides, microstrip lines and other guiding means may also serve as means for guiding high-frequency electrical power capable of propagating in a space as radio waves. Structures in which the base portion of the horn antenna and the circuit are coupled via such guiding means are also included in the technical scope of the radar apparatus disclosed herein.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A radar apparatus, for detecting an object at a place farther than a predetermined distance, comprising:
an antenna member including at least one horn antenna that performs the radiation of linearly-polarized radio waves to the object and reception of reflected waves from the object; and
a waveguide that transfers the radio waves; and
at least one circuit that performs the generation of the radio waves and the processing of a signal of the reflected waves; wherein
a base portion of the horn antenna and the waveguide are connected;
the waveguide and the circuit are coupled;
the horn antenna has a funnel shape extending from the base portion to an aperture of the horn antenna;
a cross-section of the horn antenna in a plane perpendicular or substantially perpendicular to an axis of the horn antenna has a rectangular shape;
the area of the cross-section gradually increases from the base portion toward the aperture;
an inner circumferential surface of the horn antenna includes a top surface and a bottom surface extending from the base portion toward the aperture, and a right side surface and a left side surface connecting the top surface and the bottom surface and facing each other, the top surface and the bottom surface being perpendicular or substantially perpendicular to a direction of the electrical field of the radio waves and facing each other;
the top surface and the bottom surface define a first steeply-widened portion having a first rate of a widening rate of a distance between the top surface and the bottom surface, and also define a first gently-widened portion having a second rate of a widening rate of a distance between the top surface and the bottom surface, the first gently-widened portion being positioned closer to the aperture than the first steeply-widened portion, the second rate being smaller than the first rate;
the circuit performs the extraction process of the signal from the reflected waves; and the predetermined distance is greater than ten times a length measured from the base portion to the aperture.

2. The radar apparatus according to claim 1, wherein a length of the first steeply-widened portion is smaller than a length of the first gently-widened portion in a direction of the axis of the horn antenna.

3. The radar apparatus according to claim 1, wherein
the inner circumferential surface includes bent portions in a boundary between the first steeply-widened portion and the first gently-widened portion, the widening rate varies discontinuously at the bent portions, and
lengths of the bent portions in height are equal to or wider than one wavelength but no wider than two wavelengths of the radio waves.

4. The radar apparatus according to claim 2, wherein
the inner circumferential surface has bent portions in a boundary between the first steeply-widened portion and the first gently-widened portion, the widening rate varies discontinuously at the bent portions, and
lengths of the bent portions in height are equal to or wider than one wavelength but no wider than two wavelengths of the radio waves.

5. The radar apparatus according to claim 1, wherein the right side surface and the left side surface define a second steeply-widened portion having a third rate of a widening rate of a distance between the right side surface and the left side surface, and also define a second gently-widened portion having a fourth rate of a widening rate of a distance between the right side surface and the left side surface, the second gently-widened portion being positioned closer to the aperture than the second steeply-widened portion, the fourth rate being lower than the third rate.

6. The radar apparatus according to claim 2, wherein the right side surface and the left side surface define a second steeply-widened portion having a third rate of a widening rate of a distance between the right side surface and the left side surface, and also define a second gently-widened portion having a fourth rate of a widening rate of a distance between the right side surface and the left side surface, the second gently-widened portion being positioned closer to the aperture than the second steeply-widened portion, the fourth rate being lower than the third rate.

7. The radar apparatus according to claim 3, wherein the right side surface and the left side surface define a second steeply-widened portion having a third rate of a widening rate of a distance between the right side surface and the left side surface, and also define a second gently-widened portion having a fourth rate of a widening rate of a distance between the right side surface and the left side surface, the second gently-widened portion being positioned closer to the aperture than the second steeply-widened portion, the fourth rate being lower than the third rate.

8. The radar apparatus according to claim 4, wherein the right side surface and the left side surface define a second steeply-widened portion having a third rate of a widening rate of a distance between the right side surface and the left side surface, and also define a second gently-widened portion having a fourth rate of a widening rate of a distance between the right side surface and the left side surface, the second gently-widened portion being positioned closer to the aperture than the second steeply-widened portion, the fourth rate being lower than the third rate.

9. The radar apparatus according to claim 8, wherein the inner circumferential surface includes bent portions in a boundary between the second steeply-widened portion and the second gently-widened portion, the widening rate varies discontinuously at the bent portions.

10. The radar apparatus according to claim 1, wherein the inner circumferential surface of the horn antenna includes a planar portion connecting the base portion and the first steeply-widened portion and extending perpendicularly or substantially perpendicularly to the axis.

11. The radar apparatus according to claim 2, wherein the inner circumferential surface of the horn antenna includes a planar portion connecting the base portion and the first steeply-widened portion and extending perpendicularly or substantially perpendicularly to the axis.

12. The radar apparatus according to claim 4, wherein the inner circumferential surface of the horn antenna includes a planar portion connecting the base portion and the first steeply-widened portion and extending perpendicularly or substantially perpendicularly to the axis.

13. The radar apparatus according to claim 8, wherein the inner circumferential surface of the horn antenna includes a planar portion connecting the base portion and the first steeply-widened portion and extending perpendicularly or substantially perpendicularly to the axis.

14. The radar apparatus according to claim 9, wherein the inner circumferential surface of the horn antenna includes a planar portion connecting the base portion and the first steeply-widened portion and extending perpendicularly or substantially perpendicularly to the axis.

15. The radar apparatus according to claim 1, wherein
the at least one horn antenna includes a plurality of horn antennas and the at least one circuit includes a plurality of circuits;
the plurality of horn antennas include at least one radiating horn antenna that radiates the radio waves and at least one receiving horn antenna that receives the radio waves;
the plurality of circuits include at least one transmitting circuit that generates the radio waves and at least one receiving circuit that receives the radio wave;
the transmitting circuit is coupled to the radiating horn antenna;
the receiving circuit is coupled to the receiving horn antenna; and
a height of the aperture of the radiating horn antenna is larger than a height of the aperture of the receiving horn antenna.

16. The radar apparatus according to claim 2, wherein
the at least one horn antenna includes a plurality of horn antennas and the at least one circuit includes a plurality of circuits;
the plurality of horn antennas include at least one radiating horn antenna tat radiate the radio waves and at least one receiving horn antenna that receives the radio waves;
the plurality of circuits include at least one transmitting circuit that generates the radio waves and at least one receiving circuit that receives the radio wave;
the transmitting circuit is coupled to the radiating horn antenna;
the receiving circuit is coupled to the receiving horn antenna; and
a height of the aperture of the radiating horn antenna is larger than a height of the aperture of the receiving horn antenna.

17. The radar apparatus according to claim 4, wherein
the at least one horn antenna includes a plurality of horn antennas and the at least one circuit includes a plurality of circuits;
the plurality of horn antennas include at least one radiating horn antenna that radiates the radio waves and at least one receiving horn antenna that receives the radio waves;
the plurality of circuits include at least one transmitting circuit that generates the radio waves and at least one receiving circuit that receives the radio wave;
the transmitting circuit is coupled to the radiating horn antenna;
the receiving circuit is coupled to the receiving horn antenna; and
a height of the aperture of the radiating horn antenna is larger than a height of the aperture of the receiving horn antenna.

18. The radar apparatus according to claim 8, wherein
the at least one horn antenna includes a plurality of horn antennas and the at least one circuit includes a plurality of circuits;
the plurality of horn antennas include at least one radiating horn antenna that radiates the radio waves and at least one receiving horn antenna that receives the radio waves;
the plurality of circuits include at least one transmitting circuit that generates the radio waves and at least one receiving circuit that receives the radio wave;
the transmitting circuit is coupled to the radiating horn antenna;
the receiving circuit is coupled to the receiving horn antenna; and
a height of the aperture of the radiating horn antenna is larger than a height of the aperture of the receiving horn antenna.

19. The radar apparatus according to claim 9, wherein
the at least one horn antenna includes a plurality of horn antennas and the at least one circuit includes a plurality of circuits;
the plurality of horn antennas include at least one radiating horn antenna that radiates the radio waves and at least one receiving horn antenna that receives the radio waves;
the plurality of circuits include at least one transmitting circuit that generates the radio waves and at least one receiving circuit that receives the radio wave;
the transmitting circuit is coupled to the radiating horn antenna;
the receiving circuit is coupled to the receiving horn antenna; and
a height of the aperture of the radiating horn antenna is larger than a height of the aperture of the receiving horn antenna.

20. The radar apparatus according to claim 14, wherein
the at least one horn antenna includes a plurality of horn antennas and the at least one circuit includes a plurality of circuits;
the plurality of horn antennas include at least one radiating horn antenna that radiates the radio waves and at least one receiving horn antenna that receives the radio waves;
the plurality of circuits include at least one transmitting circuit that generates the radio waves and at least one receiving circuit that receives the radio wave;
the transmitting circuit is coupled to the radiating horn antenna;
the receiving circuit is coupled to the receiving horn antenna; and
a height of the aperture of the radiating horn antenna is larger than a height of the aperture of the receiving horn antenna.
